(19) United States
(12) Patent Application Publication
(10) Pub. No.: US 2011/0112912 A1
(43) Pub. Date: May 12, 2011

(54) System and Method for an Interactive Online Social Classifieds Transaction System

(76) Inventor: En-li Wu, San Jose, CA (US)

(21) Appl. No.: 12/616,339

(22) Filed: Nov. 11, 2009

(51) Int. Cl. G06Q 30/00

(52) U.S. Cl. 705/14.73

(57) ABSTRACT

A web-based classified ads system providing tools that enable buyers and sellers to complete transactions in a social network environment. By integrating many of the transactions features such as classifieds, auctioning, bartering, event signups, with social networking elements such as profiles, chats, friend lists, groups, messages, degrees of separations, friend post notifications, feedbacks, and recommendations the system of the present invention reduces anxiety and cuts down on time and cost involved in business transactions.

### CROSS REFERENCE TO RELATED APPLICATIONS

This application claims priority from U.S. Provisional Patent Application Ser. No. 61/113,665, entitled “A System and Method for an Interactive Online Social Classifieds Transaction System”, filed on 12 Nov. 2008. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a system and method for a transactional system. More specifically, the present invention relates to an integrated website system that allows for an interactive transaction system between buyers and sellers through classified ads in a social networking setting.

### BACKGROUND OF THE INVENTION

The present invention relates to techniques for using information about a financial transaction to augment information in a representation of an online social network. A person typically values advice from people within their own social network over advice from people outside of their social network. As access to the Internet becomes more widespread, interactions between people are increasingly occurring through the Internet. For example, online social networks are appearing on the Internet, which has led to the emergence of new communities, such as Facebook, and MySpace. These online social networks enable members to quickly obtain information from other members about other members.

The present invention was created as a solution to the problem of trusting people on a classified ads site. The present invention creates a social network environment within a transaction system so that users can use the community to quickly obtain information from other members to form a confidence level in the transaction.

### SUMMARY OF THE INVENTION

A web-based classified ads system providing tools that enable buyers and sellers to complete transactions in a social network environment. By integrating many of the transactions features such as classifieds, auctioning, bartering, event signups, with social networking elements such as profiles, chats, friend lists, groups, messages, degrees of separations, friend post notifications, feedbacks, and recommendations the system of the present invention reduces anxiety and cuts down on time and cost involved in business transactions.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart illustrating how a user might interact with different parts of the website of the present invention;

FIG. 2 illustrates the advertisement post on a website page of the present invention; and

FIG. 3 illustrates a profile area of the website page of the present invention for registered providers.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

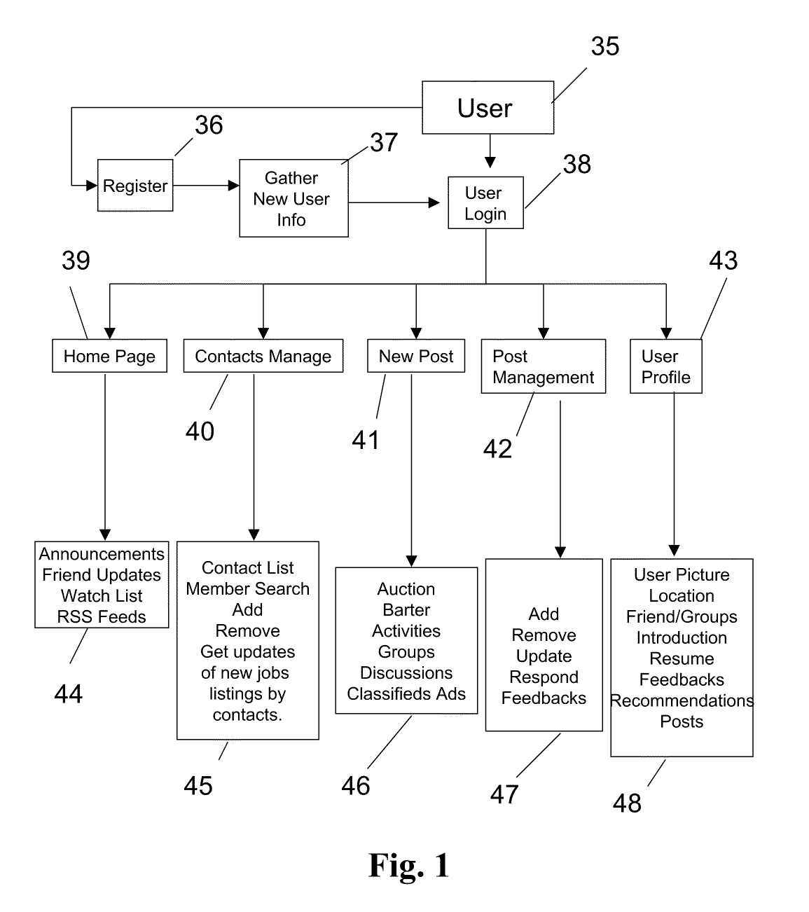

Now referring to FIG. 1, the flowchart view illustrating how a user will interact with different parts of the website is shown. Before a user 35 can login they must first register 36 and input requested user information 37 into the computer system via the website interface. Once a user is registered 36 and logged in 38, they can view a plurality of pages, including but not limited to a home page 39, contacts manager 40, forum for posting 41, post manager 42, and edit their user profile information 43 previously entered during registration 36. The system, via the website interface, will also provide announcements, friends updates, an RSS feed, and watch lists 44. Additionally, a user can search the system's database 45 for information. The transactional component 46 consists of an auction site, bartering, activities, groups, discussion forums, and classified ads. The user rating or feedback component 47 includes means for adding or removing feedback and responding to feedback left by another member. Finally, the user profile database 48 may also include a picture or video and other information such as location, group and friend connections, an introduction, resume, recommendations, feedback, and a post history.

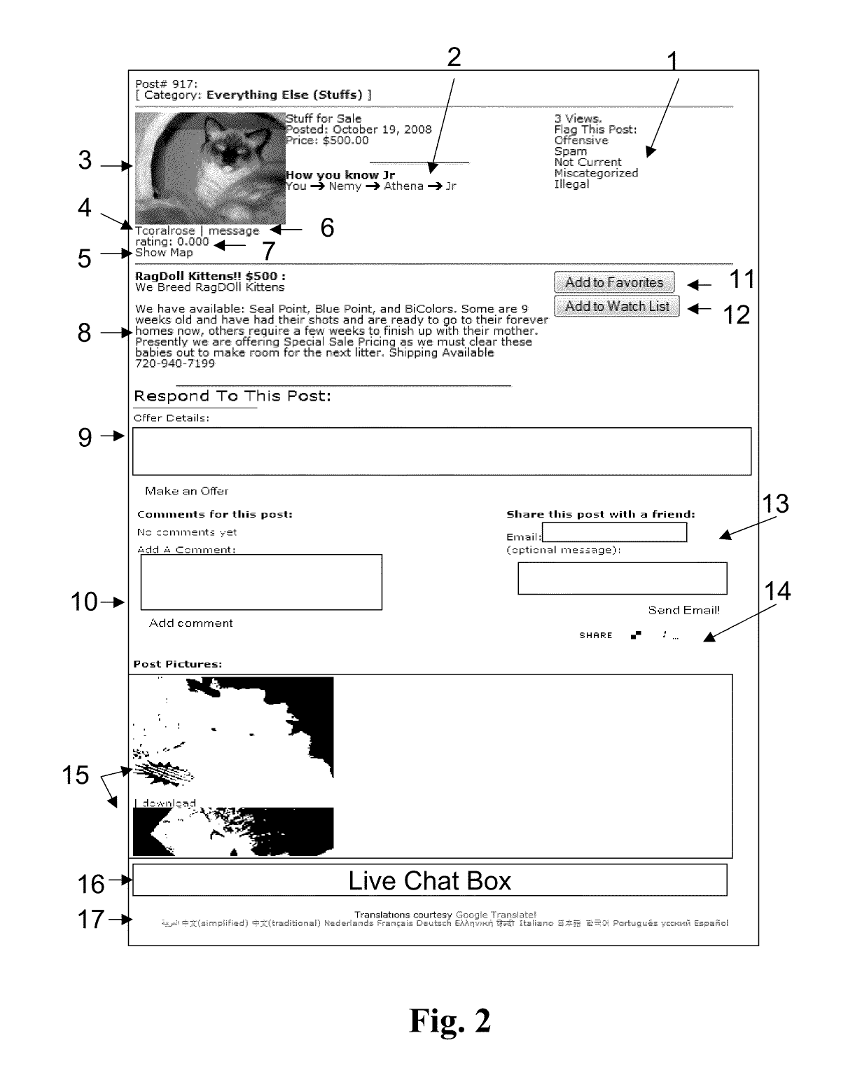

Now referring to FIG. 2 the advertisement post website page of the present invention is illustrated. The advertisement post website page is designed to provide the user with a wealth of information to make decisions easier. The advertisement post website page consists of: A flagging system that allows users to report inappropriate, illegal, or out of date posts 1. A degree of separation chain makes it easier to connect and trust the poster 2. A picture of the poster's logo or picture 3, link to a poster's profile page 4, direction map to that user 5 and means to allow a message to be send to that user 6 are also provided. Also provided is a Feedback rating 7 that a running average of the feedback scores. A post title and description 8 section is present for showing items listed. A response (offer) box 9 enables users to make offers or confirm a deal while a comment box 10 allows a user to make comments and ask questions. Additionally, a user can add the offer to the website's favorites list and allows other users to see 11 is and add the offer to a user's watch list for ease of monitoring 12. A share box 13 sends out an email invite to a friend to view this post. Social book marking 14 enables users to use third party social booking service to share it with their network. Pictures 15 provide a place for pictures and lets users download them. A live chatting box 16 enables users to start a conversation about the post with other users on that page. A translation box 17 provides a third party translation program that translates the page with other languages.

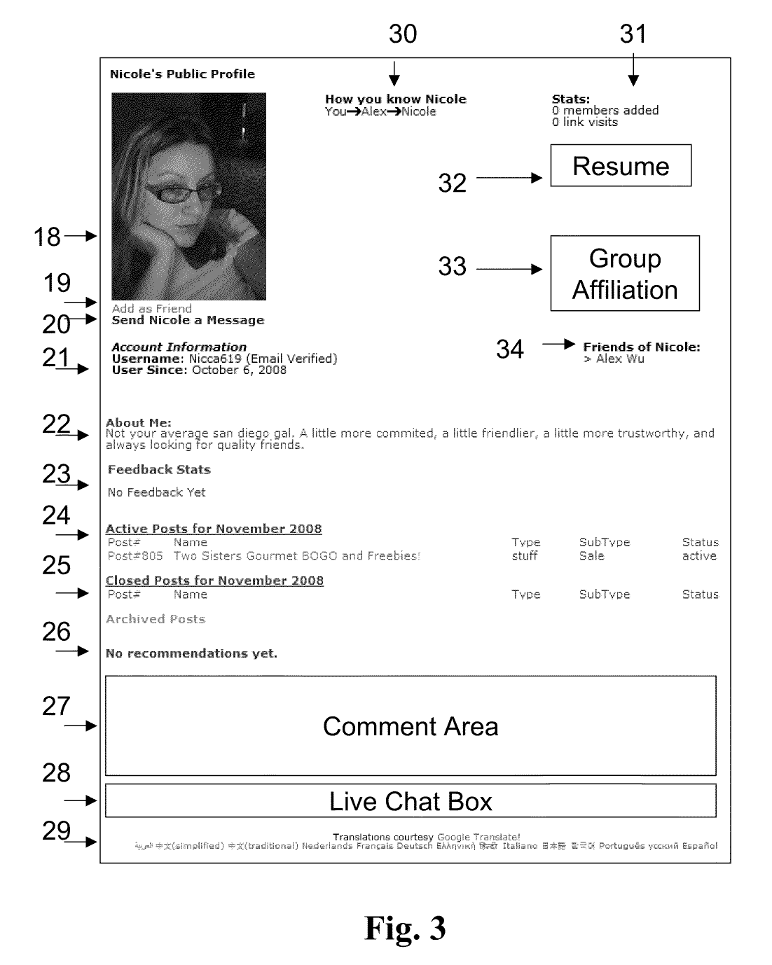

Now referring to FIG. 3, a profile area for registered providers is shown. This area helps individuals build their personal brand and provide useful information for anyone who is interested in doing business with those individuals. The profile area consists of: a profile picture of the individual or business 18; User info, such as onsite user name, and date joined which adds to the trust factor 21; Description area for that user to make a self-introduction 22; Feedback area which records all the feedbacks that user has received from past transaction 23; List of current active postings 24; List of closed/expired postings 25; and a recommendation area 26 where said user may receive recommendations from people on his/her friend list. This recommendation area 26 helps a new user, who lacks transaction feedbacks, to establish some credibility. The profile area also consists of: a resume link 32 to a user's profile; a comment area 27 which allows other users to leave comments regarding that profile; a live chat box 28 that allows users who are on the page to start a conversation on that profile; a third party language translation software 29 which translates the contents of the profile page into different languages; a group affiliation list 33 which is a list of groups that said user participates within the site; and a friend list 34 that is a list of friends the user has within the site. Additionally, the website provides a function that allow the current viewer of the page to add the viewee to his/her friend list 19 and a function that sends an email to that user 20. A degrees of separation 30 module creates a simple relationship chart that maps the social distance between the current user viewing that profile and profile owner. Finally, a referral tracking 31 module tracks the number of referrals the user has established.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

1. A method for an interactive online social classifieds transaction system by a software program executed on a computer system comprising the steps of:
a. providing a computer server accessible by service providers, product retailers, and registered users;
b. allowing service providers and product retailers to post their advertisements;
c. allowing registered users to ask questions and provide comments regarding an advertisement;
d. providing means for allowing a registered user's profile to be viewed;
e. allow registered users to places offers on an advertisement;
f. allow registered users to mark an advertisement for future reference; and
g. providing a platform for performing a sales transaction.

2. The method of claim 1 wherein said user profile includes:
a place for introduction of the users;
feedbacks and past transactions;
comments and recommendations;
friend & group affiliations; and
degrees of separations.

3. The method of claim 1 further comprising the steps of:
h. registering and inputting requested user information by a user into the computer system via a website interface;
i. storing said user information in a system database; and
j. viewing a plurality of pages after registration and login.

4. The method of claim 3 wherein said viewable pages include:
a home page;
contacts manager;
forum for posting;
post manager; and
user profile information editor.

5. The method of claim 1 further comprising the steps of:
k. providing announcements;
l. providing friends updates;
m. providing an RSS feed; and
n. providing a watch lists of post advertisements.

6. The method of claim 1 further comprising the step of:
o. searching the system's database.

7. The method of claim 1 further comprising a transactional component consisting of:
an auction site;
bartering;
activities;
groups;
discussion forums; and
classified ads.

8. The method of claim 1 further comprising:
a transactional component consisting of a user rating and feedback component includes means for:
adding or removing feedback; and
responding to feedback left by another member.

9. The method of claim 3 wherein the user profile database includes a picture or video;
location information;
group information;
friend connections;
an introduction;
a resume;
recommendations;
feedback; and
a post history.

10. The method of claim 1 wherein the advertisement post website page includes:
a flagging system that allows users to report posts;
a degree of separation chain;
a picture of the poster's logo or picture;
a link to a poster's profile page;
a direction map to that user; and
means to allow a message to be send to the posting user.

11. The method of claim 1 further comprising the steps of:
p. provided a feedback rating that is a running average of the feedback scores;
q. providing a post title and description section for showing items listed;
r. providing a response/offer box;
s. enabling users to make offers or confirm a deal;
t. providing a comment box; and
u. allowing a user to make comments and ask questions via the comment box.

12. The method of claim 11 further comprising the steps of:
v. adding an offer to the website's favorites list;
w. allowing other users to see the offer;
x. adding the offer to a user's watch list for ease of monitoring;
y. providing a share box sending out an email invite to a friend to view a post.

13. The method of claim 12 further comprising a social book marking enabling users to use third party social booking services to share information with their network.

14. The method of claim 12 further comprising a live chatting box enabling users to start a conversation about the post with other users on that page.

15. The method of claim 14 further comprising a translation box providing a translation program that translates the page with other languages.

16. The method of claim 4 wherein the profile consists of:
a profile picture of the individual or business;
user info, such as onsite user name, and date joined;
description area for the user to make a self-introduction;
feedback area which records all the feedback that a user has received from past transactions;
a list of current active postings;
a list of closed/expired postings; and
a recommendation area where said user may receive recommendations from people on his/her friend list;
a resume link to a user's profile;
a comment area which allows other users to leave comments regarding the profile;
a live chat box that allows users who are on the page to start a conversation on that profile;
a group affiliation list which is a list of groups that said user participates within the site; and
a friend list that is a list of friends the user has within the site.

17. The method of claim 16 further comprising a translation box providing a translation program that translates the page with other languages.

18. The method of claim 12 further comprising the step of:
z. allowing a current viewer of a page to add the viewee to his/her friend list and send an email to that user.

19. The method of claim 12 further comprising the step of:
aa. providing a degrees of separation module creates a simple relationship chart that maps the social distance between the current user viewing that profile and profile owner.

20. The method of claim 19 further comprising the step of:
bb. providing a referral tracking module that tracks the number of referrals the user has established.
